(19) United States
(12) Patent Application Publication
(10) Pub. No.: US 2006/0173719 A1
(43) Pub. Date: Aug. 3, 2006

(54) Message-based connectivity manager

(75) Inventors: Alan E. Kuhn, Wauwatosa, WI (US); Timothy J. Kaschinske, Hartland, WI (US); Paul A. Seifert, Waukesha, WI (US)

Correspondence Address: MICHAEL BEST & FRIEDRICH, LLP, 100 E WISCONSIN AVENUE, MILWAUKEE, WI, 53202, US

(73) Assignee: Agfa Corporation, Ridgefield Park, NJ (US)

(21) Appl. No.: 11/045,220

(22) Filed: Jan. 28, 2005

(51) Int. Cl. G06F 19/00; G06F 3/00

(52) U.S. Cl. 705/3; 715/700

(57) ABSTRACT

A connectivity manager for use in a medical information system. The medical information system can include a facility information system, a medical imaging ordering system, and a picture archiving system, and the connectivity manager can be configured to use message-based communications to receive messages from the medical imaging ordering system, store reports in the picture archiving system, and retrieve reports from the picture archiving system.

### BACKGROUND OF THE INVENTION

Many information systems use what is sometimes called “middleware,” a “gateway,” or a “broker” to facilitate communications between different devices, software, or both. For example, in some instances a type of middleware is used to facilitate communication between clients and servers in such a way that the client need not be aware of or have knowledge of the operation or structure of servers connected to a network. In theory, at least, the client may submit a request, which the middleware processes and sends to an appropriate server. The selected server may generate a response that is sent to the middleware. The middleware forwards the response to the client.

### SUMMARY OF THE INVENTION

Although middleware, gateways, and brokers (referred to generally herein as “connectivity managers”) exist they are not always satisfactory or usable in a particular system or circumstance. Thus, there is a need for an improved connectivity manager. There is a more particular need for a connectivity manager that is useful in medical information systems.

Some embodiments of the invention provide a connectivity manager for use in a medical information system. The medical information system can include a facility information system, a medical imaging ordering system, and a picture archiving system. The connectivity manager can be configured to use message-based communications to receive messages from the medical imaging ordering system, store reports in the picture archiving system, and retrieve reports from the picture archiving system.

Additional embodiments provide a method of storing a first medical report in a medical information system. The medical information system can include a medical imaging ordering system, a connectivity manager, and a picture archiving system. The method can include transmitting the first medical report in a first message from the medical imaging ordering system to the connectivity manager; generating a second message with a second medical report based on the first medical report, transmitting the second message to the picture archiving system from the connectivity manager without internally storing the first report or the second report, and storing the second medical report to the picture archiving system when the medical imaging ordering system is not a queriable device; and ignoring the first message without internally storing the first report when the medical imaging ordering system is a queriable device.

Another embodiment provides a method of retrieving a medical report in a medical information system. The medical information system can include a medical imaging ordering system, a connectivity manager, and a picture archiving system. The method can include transmitting a report query for a report to the connectivity manager; generating a first query, transmitting the first query from the connectivity manager to the medical imaging ordering system, and retrieving the report from the medical imaging ordering system when the medical imaging ordering system is a queriable device; and generating a second query, transmitting the second query from the connectivity manager to the picture archiving system, and retrieving the report from the picture archiving system when the medical imaging ordering system is not a queriable device.

Yet another embodiment provides a connectivity manager for use in a medical information system. The medical information system can include a medical imaging ordering system and a picture archiving system. The connectivity manager can include an input device configured to interact with the medical imaging ordering system and to convert a message from a first format to a second format; a business logic server configured to interact with the input device and to generate a report; a data store configured to interact with the business logic server; a report storing interface configured to interact with the business logic server and the picture archiving system; a report browser interface configured to interact with the business logic server; and a report status interface configured to interact with the business logic server.

Some embodiments also provide a connectivity manager for use in a medical information system. The medical information system includes a queriable medical imaging ordering system and a picture archiving system. The connectivity manager can be configured to receive a first message including a first report from the medical imaging ordering system, and, if the first report includes a first status not equal to a predetermined status, to generate a second report based on the first report and to transmit a second message including a second report to the picture archiving system.

Other features and aspects of embodiments of the invention will become apparent to those skilled in the art upon review of the following detailed description, claims, and drawings.

### BRIEF DESCRIPTION OF THE DRAWINGS

In the drawings:

FIGS. 1-4 are schematic illustrations of exemplary medical information systems.

FIG. 5 is a schematic illustration of exemplary components of a connectivity manager.

FIGS. 6-13 are schematic illustrations of exemplary data flow between components of a medical information system.

### DETAILED DESCRIPTION

It is to be understood that embodiments of the invention are not limited in application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

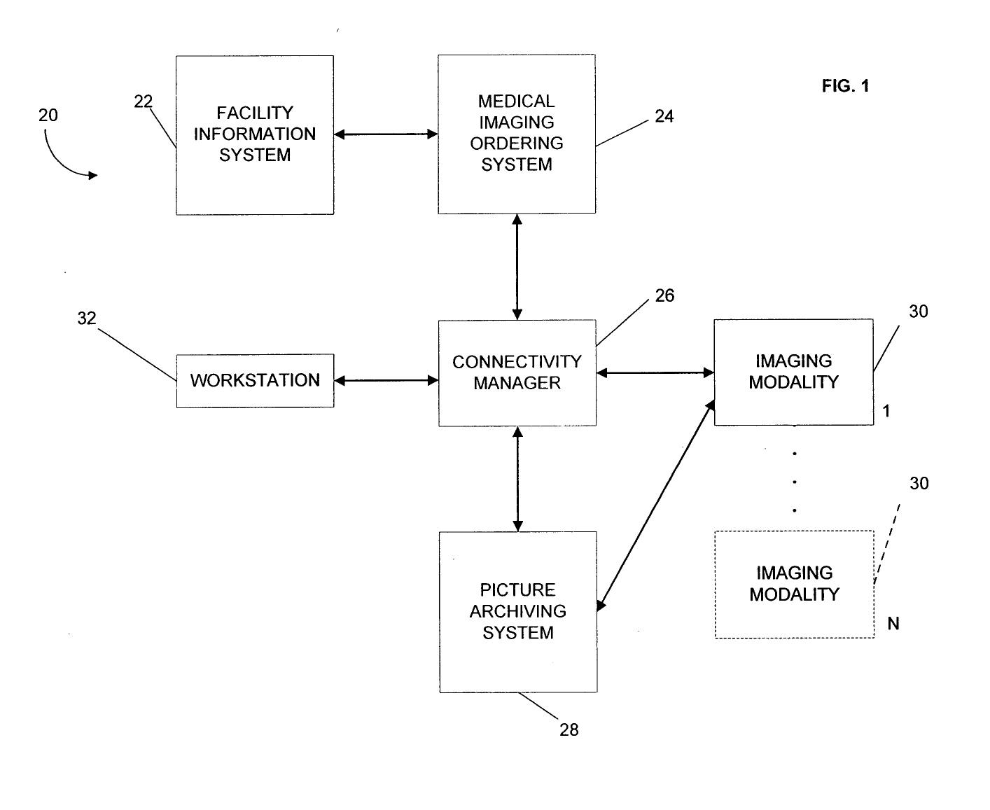

FIG. 1 illustrates an exemplary medical information system 20. The system 20 includes a facility information system (“FIS”) 22, a medical imaging ordering system (“MIOS”) 24, a connectivity manager 26, a picture archiving system (“PAS”) 28, an imaging modality 30, and a workstation 32. In some embodiments, the FIS 22 includes a hospital information system (“HIS”) operable to obtain patient demographics, schedule patient procedures and procedure studies, regulate billing and financial data related to the services provided to patients, and the like. The FIS 22 can communicate with the MIOS 24 to schedule procedures and procedure studies for patients requiring particular services. For example, the MIOS 24 can include a radiology information system (“RIS”) configured to schedule, record, and manage radiology procedures and studies. In some embodiments, the functionality that the FIS 22 and the MIOS 24 provide can be combined as a single component of the system 20. In some embodiments, the FIS 22 and/or MIOS 24 are also queriable devices and are configured to accept queries and provide data in response to the queries.

The MIOS 24 may communicate with the connectivity manager 26. The connectivity manager 26 may act as middleware between the MIOS 24 and the PAS 28. As illustrated in FIG. 1, the FIS 22 may also indirectly communicate with the connectivity manager 26 through the MIOS 24. In some embodiments, the FIS 22 communicates with the connectivity manager 26 directly without going through the MIOS 24.

The connectivity manager 26 may process and/or format message-based communications between the MIOS 24 and the PAS 28. In contrast to client-server-based communications where a client queries a server for data (e.g., whether or not an event has occurred or changes have been made to the server), message-based communications are transmitted from a component when it becomes aware of an event occurring (e.g., when a patient is admitted, when a procedure is scheduled, when a procedure is completed, etc.). Using message-based communications, the connectivity manager 26 may listen and await messages from the MIOS 24, process the message, and forward the message to the PAS 28. In some embodiments, data transmitted from the FIS 22 and/or MIOS 24 is packaged and transmitted according to a specific protocol. The FIS 22 and MIOS 24 may utilize the health level 7 (“HL7”) protocol to format outgoing messages. In a medical or healthcare environment, an HL7 message may be sent from the FIS 22 and/or MIOS 24 when a patient checks in, is transferred, or is discharged; when a procedure is scheduled; when a procedure is completed; or when other events occur. The HL7 message may include patient data, scheduling data, procedure data, and any combination thereof. An exemplary HL7 message that may be generated when a patient checks into a facility is illustrated below.

MSH|\hat{ }˜\&|ABCCO|ABCCO123|SMS|SMSADT|199912271408|
CHARRIS|ADT\hat{ }A04|1817457|D|2.3|
EVN|A04|199912271408|||CHARRIS
PID||0493575\hat{ }\hat{ }\hat{ }2\hat{ }ID 1|454721||DOE\hat{ }JOHN\hat{ }\hat{ }\hat{ }\hat{ }|DOE\hat{ }JOHN\hat{ }\hat{ }\hat{ }\hat{ }|
19480203|M||B|254
E238ST\hat{ }\hat{ }EUCLID\hat{ }OH\hat{ }44123\hat{ }USA||(216) 731-4359|||M|NON|
400003403˜1129086|999-|
NK1||CONROY\hat{ }MARI\hat{ }\hat{ }\hat{ }\hat{ }|SPO||(216) 731-4359||
EC|||||||||||||||||||||||||||
PV1||O|168 ˜219˜C˜PMA\hat{ }\hat{ }\hat{ }\hat{ }\hat{ }\hat{ }\hat{ }\hat{ }\hat{ }||||
277\hat{ }ALLEN FADZL\hat{ }BONNIE\hat{ }\hat{ }\hat{ }\hat{ }||||||||||
||2688684|||||||||||||||||||||||||199912271408||||||002376853

The HL7 protocol defines the type of data that may be included in a message, but does not specify or require a format for the data. Two applications or systems may generate an HL7 message regarding the transfer of a patient and both messages will contain the same data, but the format of the data in the two messages may be different. For example, one application or system may record the gender of a patient as “MALE” or “FEMALE” while another application records gender as “M” or “F.”

In some embodiments, the PAS 28 structures data differently than the MIOS 24 and may require inbound messages to be packaged in a different way than they are sent from the medical imaging system 24. The connectivity manager 26 may act as an adapter to convert messages sent from the MIOS 24 into messages acceptable to the PAS 28. In some embodiments, the connectivity manager 26 converts HL7 messages received from the MIOS 24 into a digital imaging and communications in medicine (“DICOM”) format acceptable to the PAS 28. The connectivity manager 26 may also be configured to convert received messages into one or more vendor-specific formats, allowing messages and data to be circulated and used across a number of systems, networks, and platforms.

The connectivity manager 26 can also combine data from multiple messages and/or from multiple input devices and/or databases to create a single message for the PAS 28. In some embodiments, the connectivity manager 26 receives procedure data in an HL7 message from the MIOS 24 and combines the procedure data with patient data to create a procedure study or report which is provided to the PAS 28 for storage. In some embodiments, the connectivity manager 26 does not provide short or long-term storage of the procedure results and/or reports and may not internally store the results and/or reports. The connectivity manager 26 may rely solely on the data repository functionality of external devices, such as the PAS 28 and/or the MIOS 24, rather than providing internal data storage for the procedure studies and/or reports.

Upon receiving messages and/or data from the connectivity manager 26 or other devices, the PAS 28 may operate as a data repository for the received data. In some embodiments, the PAS 28 may include one or more structured query language (“SQL”) tables configured to store data from the connectivity manager 26. The PAS 28 may also receive data from one or more image modalities 30. The imaging modality 30 may include computer-aided tomography (“CAT”) scan equipment, ultrasound equipment, magnetic resonance imaging (“MRI”) equipment, X-ray equipment, and the like. The imaging modality 30 obtains pictures or images and data during a procedure for a patient and transmits the images to the PAS 28. The imaging modality 30 may use the DICOM protocol to transmit acquired images to the PAS 28.

In some embodiments, one or more imaging modalities 30 also communicate with the connectivity manager 26 to obtain worklists. The worklists may include a schedule of procedures to be performed with the imaging modality 30. The worklists may be transmitted from the MIOS 24 or the FIS 22 to the connectivity manager 26 for distribution. The connectivity manager 26 may also generate worklists for the imaging modality 30 from data received from the MIOS 24, FIS 22, or other external device or application. In some embodiments, the connectivity manager 26 may communicate with the image modality 30 through the PAS 28. The connectivity manager 26 may also store a worklist to the PAS 28 where the imaging modality 30 retrieves the worklist when needed. The imaging modality 30 may also receive a worklist directly from the MIOS 24 and/or FIS 22. The imaging modality 30 may also communicate the status and/or results of procedures to the MIOS 24 and/or FIS 22 either directly or through the connectivity manager 26.

The workstation 32 may be used to view and/or edit data stored in the PAS 28. For example, a doctor, technician, or specialist may use the workstation 32 to query the PAS 28 for images and/or procedure studies. A doctor may also be able to retrieve and print data at the workstation 32. In some embodiments, the workstation 32 communicates with the PAS 28 directly rather than through the connectivity manager, and the PAS 28 forwards the communications from the workstation 32 to the connectivity manager 26.

It should be understood that the system 20 may include additional components such as multiple facility information systems 22, medical imaging ordering systems 24, picture archiving systems 28, workstations 32, modems, routers, servers, printers, and like.

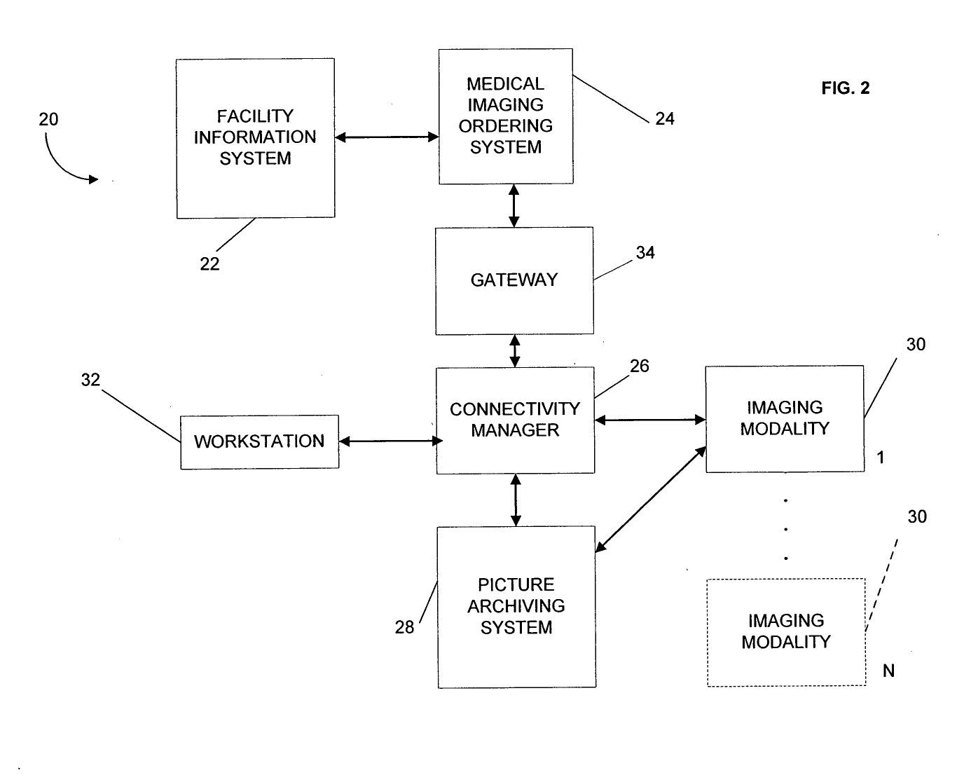

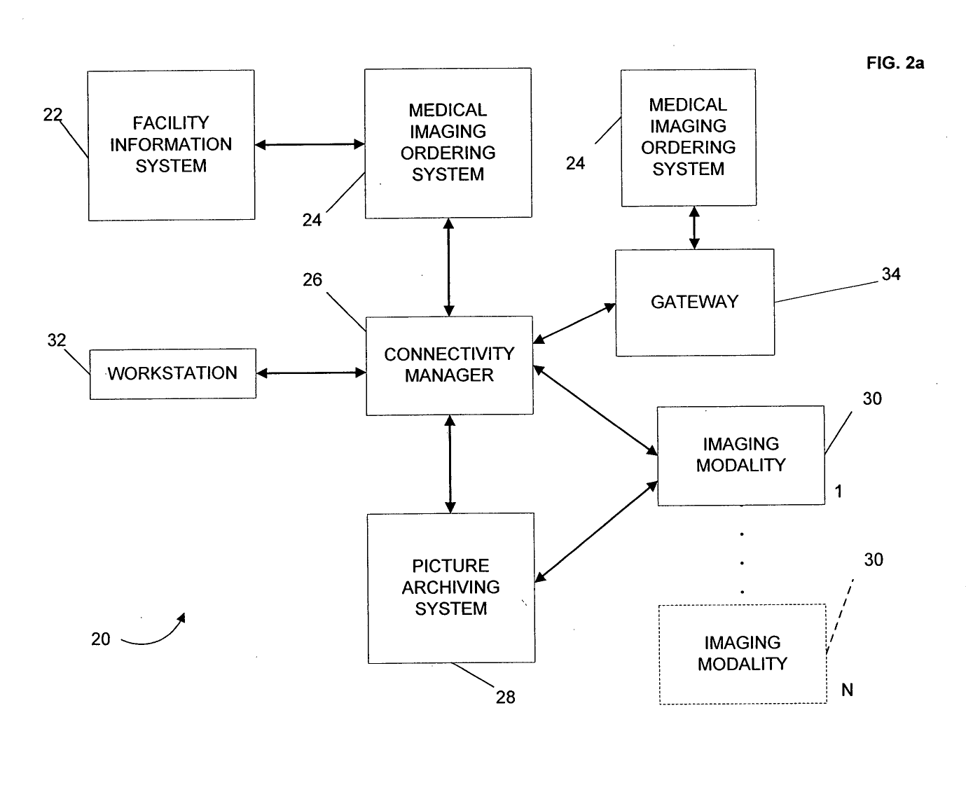

As seen in FIG. 2, the connectivity manager 26 can indirectly communicate with components of the system 20, such as the FIS 22 and the MIOS 24. In some embodiments, the system 20 includes a gateway or middleware 34. The gateway 34 provides an adapter between devices that communicate using proprietary or non-public protocols or formats and the connectivity manager 26. The gateway 34 may be a legacy or proprietary-format gateway or adapter that understands the proprietary protocols or formats used by systems, such as a facility information system, medical imaging ordering system, and/or an imaging modality, that communicate using proprietary or legacy formats or protocols. The gateway 34 may also understand or be configured to understand standard protocols so that the connectivity manager 26 can communicate with the gateway 34. In some embodiments, the connectivity manager 26 uses message-based communications to communicate with the gateway 34. The connectivity manager 26 and the gateway 34 may exchange DICOM and/or HL7 messages. It should be understood that the connectivity manager 26 may use other types of messages and communication protocols other than message-based protocols to communicate with the gateway 34.

As illustrated in FIG. 2a, in some embodiments, the connectivity manager 26 communicates with one or more facility information systems 22 and/or one or more medical imaging ordering systems 24 directly and one or more facility information systems 22 and/or medical imaging ordering systems 24 through the gateway 34.

The system 20 may also include an authentication server (e.g., a lightweight directory access protocol (“LDAP”) server) that maintains authentication data such as usernames, passwords, access rights, and the like. The system 20 may also include an audit log repository that maintains healthcare insurance portability and accountability (“HIPPA”) audit logs. In some embodiments, the connectivity manager 26 sends audit messages to the audit log repository using the Syslog protocol, which follows the user datagram protocol (“UDP”). The connections illustrated between the components may also be wired and/or wireless connections over one or more networks or communication systems such as the Internet, the telephone system, wireless networks, satellite networks, cable TV networks, and various other private and public networks.

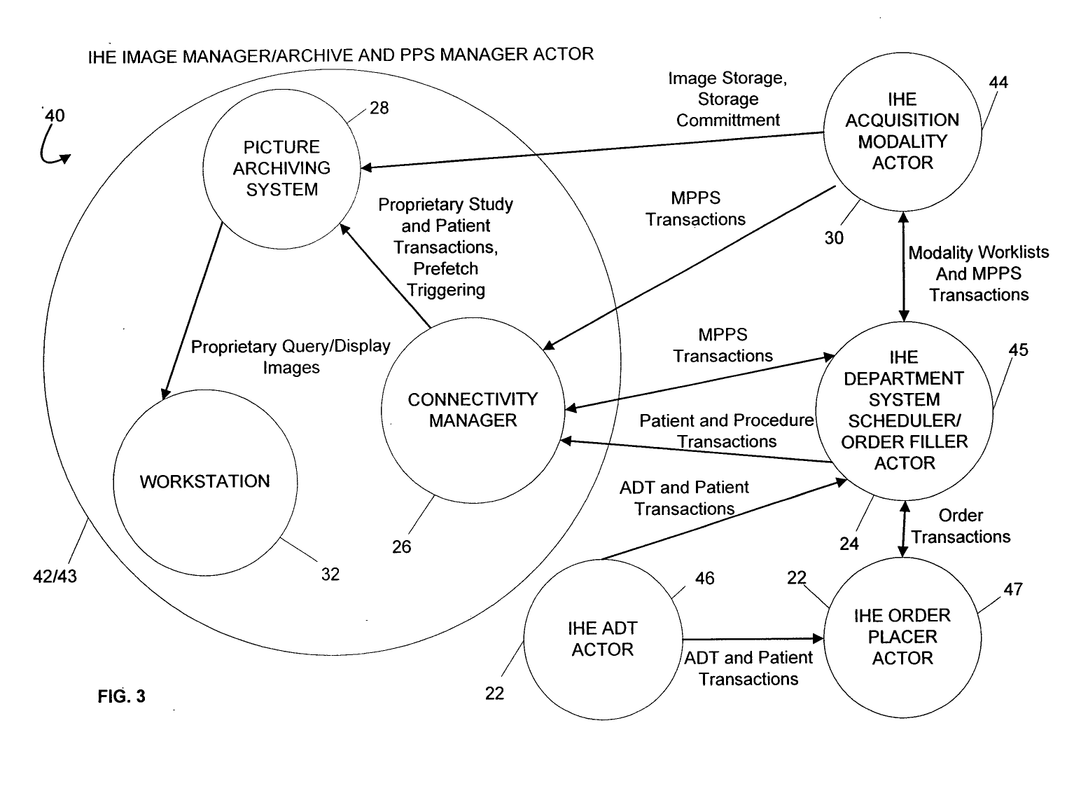

FIG. 3 illustrates another exemplary medical information system 40. In some embodiments, the system 40 supports the Integrating the Healthcare Enterprise (“IHE”) initiative. The IHE initiative attempts to improve the interoperability of modalities and information systems and establishes defined frameworks of actors and transactions between actors during workflow. The actors define the functionality and responsibilities of modalities in a system, and the transactions define the interoperability between actors during workflow. In particular, the system 40 supports the IHE scheduled workflow (“SWF”) and Patient Information Reconciliation (“PIR”) integration profiles concepts. In the context of integration profiles, the connectivity manager 26, PAS 28, and workstation 32 play two roles. The first role is an IHE image manager/archive actor 42, and the second role is as an IHE procedure performed step (“PPS”) manager 43. The IHE image manager/archive actor 42 receives evidence objects as an output of a patient procedure. Evidence objects may include images, procedure results and/or studies, procedure schedules, patient updates, and the like. The image manager/archive actor 42 may obtain evidence objects from an IHE acquisition modality actor 44 or the IHE department system scheduler/order filler actor 45. The IHE acquisition modality actor 44 may be similar to the imaging modality 30 as described above, and the IHE department system scheduler/order filler actor 45 may be similar to the MIOS 24 also described above. The IHE image manager/archive actor 42 and, in particular, the PAS 28 provide storage and management of evidence items.

In some embodiments, the PPS manager 43 is supplied with data about procedures. The PPS manager 43 may provide and receive procedure data to and from the IHE acquisition modality actor 44 before, during, and after the procedure is performed. The PPS manager 43 may also exchange procedure data regarding scheduling and patient transactions with the IHE department system scheduler/order filler actor 45. The IHE department system scheduler/order filler actor 45 may also receive scheduling and patient data from an IHE admission discharge and transfer (“ADT”) actor 46 and/or an IHE order placer actor 47. The IHE ADT actor 46 and IHE order placer actor 47 may provide functionality similar to the functionality described for the FIS 22 above. The PPS manager 43 and, in particular, the connectivity manager 26 may act as an adapter between the IHE image modality actor 44 and the IHE department system scheduler/order filler actor 45. The connectivity manager 26 may be operable to accept messages transmitted from the IHE acquisition modality actor 44 (e.g., DICOM messages) and to transmit messages to the IHE department system scheduler/order filler actor 45 in the appropriate form (e.g., HL7).

As also illustrated in FIG. 3, the IHE department system scheduler/order filler actor 45 also may communicate with the IHE acquisition modality actor 44 without first communicating with the IHE PPS manager 43, or in particular, the connectivity manager 26. The IHE department system scheduler/order filler actor 45 may exchange modality worklists and modality procedure performed step (“MPPS”) transactions directly with the IHE acquisition modality actor 44.

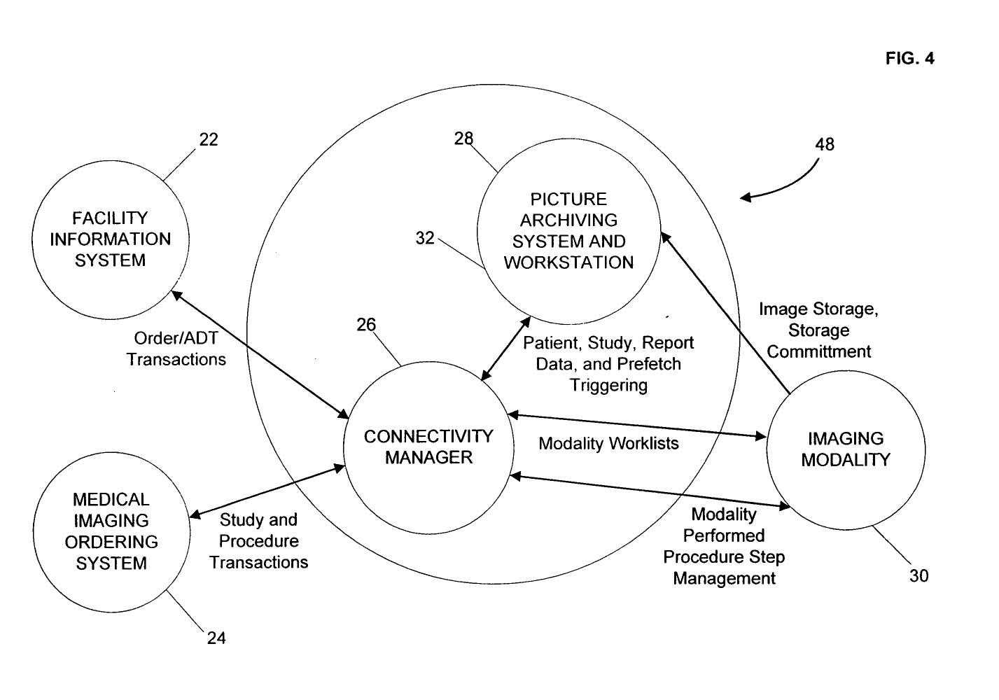

FIG. 4 illustrates another exemplary medical information system 48 that provides a non-IHE environment. The system 48, which is similar to the system 20 illustrated in FIGS. 1 and 2 and described above, provides a link between an input side including the FIS 22 and MIOS 24 and an output side containing one or more image modalities 30 through the connectivity manager 26. In comparison to the system 40 illustrated in FIG. 3, the connectivity manager 26 in the system 48 communicates a worklist to the imaging modality 30 rather than the IHE department system scheduler/order filer actor 45. As previously described, a worklist may be transmitted from the FIS 22 or MIOS 24 to the connectivity manager 26 for delivery to the imaging modality 30. The connectivity manager 26 may also create a worklist for the imaging modality 30.

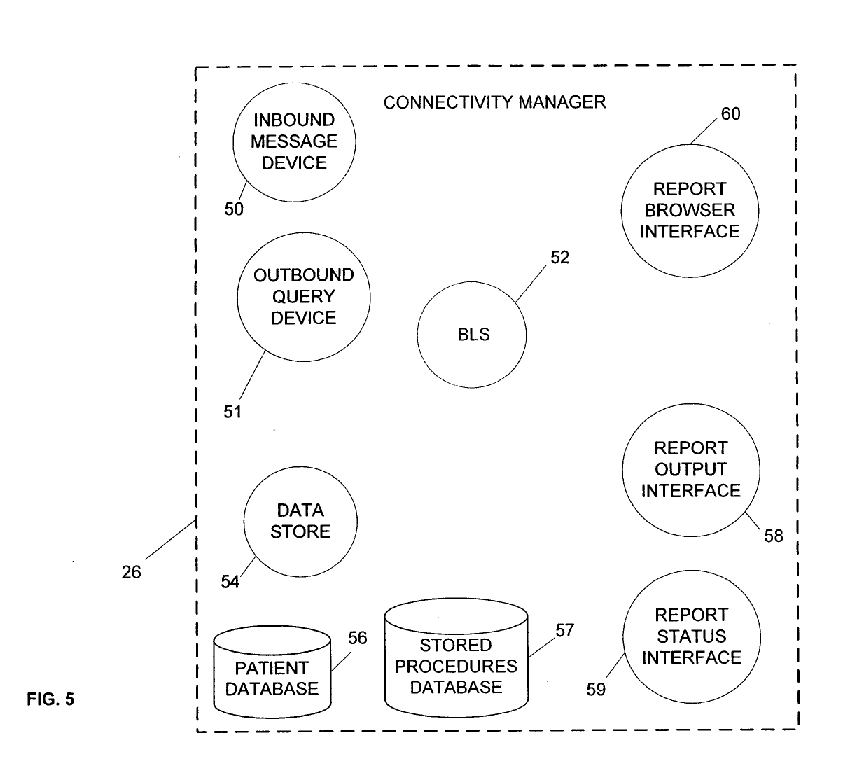

FIG. 5 illustrates exemplary components or modules within the connectivity manager 26. In some embodiments, the connectivity manager 26 includes an inbound message device 50, an outbound query device 51, a business logic server (“BLS”) 52, a data store (“DS”) 54, a patient database 56, a stored procedures database 57, a report storing interface 58, a report status interface 59, and a report browser interface 60. The inbound message device 50 may be configured to listen for and receive messages from input devices such as the FIS 22 or MIOS 24. The inbound message device 50 may also be configured to parse and interpret the data contained within a received message to generate a message in an internal format of the connectivity manager 26. In some embodiments, the inbound message device 50 may format the received message into a message following an attribute/value pair (“AVP”) protocol with sequenced items, such as the Mitra Common Framework (“MCF”) protocol. The inbound device 50 may also format received messages according to other standard or proprietary protocols.

The outbound query device 51 may operate in a reverse manner as described for the inbound message device 50. In some embodiments, the outbound query device 51 converts internal queries and/or messages of the connectivity manager 26 in an internal format into queries and/or messages acceptable to an input device, such as the MIOS 24. The outbound query device 51 may also be configured to receive responses to the queries from the input devices. Responses to queries transmitted from the outbound query device 51 may also be transmitted to the inbound message device 50 as described above.

After formatting a received message, the inbound message device 50 may forward the message to the BLS 52. The formatted message may include, in addition to the data sent from the input device, instructions to the BLS 52 specifying what should be done with the data. For example, if the MIOS 24 sends procedure results, the inbound message device 50 may instruct the BLS 52 to generate and store a report to the PAS 28 from the received data. The received data may also be provided to the BLS 52 with an instruction to update a previously stored report.

The BLS 52 may require additional data other than that sent from the inbound message device 50, and may query the DS 54 to obtain additional data. The BLS 38 may query or message the DS 54 using the MCF protocol or another messaging protocol. The DS 54 may operate as an AVP database access layer. The DS 54 may receive MCF messages from the BLS 52 and use the data in the message to query, update, or modify the patient database 56. The patient database 56 may include patient data, procedure order data, or procedure study data, and/or other demographic data. The patient database 56 may also contain past procedure results and/or procedures studies that may be incorporated with current procedure results. The DS 54 may translate MCF messages into a standard database access language that the patient database 56 understands, such as open database connectivity (“ODBC”). The DS 54 may also format the data obtained from the patient database 56 into a format acceptable to the BLS 52, such as the MCF format.

The BLS 52 may be configured to generate reports from the data received from the input devices and any additional data obtained from the patient database. In some embodiments, a report is generated in a markup language such as hypertext markup language (“HTML”) or extensible markup language (“XML”). Generated reports may be sent to the PAS 28 for storage through the report storing interface 58. The report storing interface 58 may transmit generated reports using a markup language-based messaging protocol acceptable to the PAS 28, such as the simple object access protocol (“SOAP”).

The report status interface 59 may also communicate with the PAS 28 to set and update the status of a stored report. The BLS 52 may send status update instructions to the report status interface 59 and the report status interface 59 may communicate the data to the PAS 28. In some embodiments, the report status interface 59 communicates with the PAS 28 using the DICOM protocol and may include a DICOM adapter such as the Agfa AS300 adapter. The status of a report may be kept separate from the actual report to provide a reference table for the stored reports. A report may be marked as preliminary, read-only, final, and the like. The status of a report may designate the operations that can be performed on the report. For example, a preliminary report may not be available for viewing or may only be accessible to particular users. A report with a status of final may also be restricted from being updated.

In some embodiments, the report browser interface 60 provides an interface for the workstation 32 to query reports stored in the PAS 28. The workstation 62 may interact with the report browser running on a report or web server to access and view a report. The report browser interface 60 may include an active server page (“ASP”) browser interface configured to provide a hypertext transport protocol (“HTTP”) query interface that retrieves one or more reports for display in HTML. In some embodiments, the query interface allows a user to query for a report based on a patient identification and/or accession number.

The report browser interface 60, as well as the other components of the connectivity manager 26, may be configured on a common platform that may increase the interoperability and communication between components. For example, the report browser may be wrapped in a .Net web service to provide a common interface to the report storing interface 58. The report browser interface 60 may also include a generally language-independent component-based application, such as a COM+application. The component-based application may include one or more objects or discrete components that each have a unique identity and known interface that allows other applications and components to access their features.

In some embodiments, the report browser interface 60 receives a report query from a workstation 32 and forwards the query or creates and transmits a formatted query or message to the BLS 52. The BLS 52 may, in turn, retrieve the specified report from the PAS 28 and return the report to the report browser interface 60. In some embodiments, the report browser interface 60 forwards the returned report to the workstation 32 where it is displayed for a user. A user may also be able to modify a displayed report on one of the workstations 32. A user may modify data, add comments, link images, print a report, or the like using the workstation 32 and input and output peripherals such as a keyboard, cursor control device, and/or printer (not shown). The report browser interface 60 may also be configured to display reports in multiple formats depending on the origin of the report query. For example, if a user messages the connectivity manager 26 over the Internet, local area network (LAN), or other network connection, the report browser 60 may generate a portable document format (“PDF”) or other common format of the report returned from the BLS 52 so that a specific display application is not required to view the report on the workstation 32. In some embodiments, editing the displayed report, however, may only be available when using a specific report viewing application.

The workstation 32 may transmit queries and/or messages to the report browser interface 60 using HTTP or similar protocols, such as transmission control protocol/Internet protocol (“TCP/IP”); The report browser interface 60 may also communicate with the BLS 52 using HTTP, MCF, HL7, or other transmitting protocols. The workstation 32 may also directly communicate with the BLS 52.

The stored procedures database 57 may store procedures for querying the connectivity manager 26 for reports. In some embodiments, a viewing application running on a web/application server interacts with the stored procedures database 57 to generate report queries for retrieving reports for viewing and/or modifying. A procedure is accessed from the stored procedures database 57, formatted as needed to retrieve a report that a user or external device specifies using the viewing application, and forwarded to the BLS 52. The BLS 52 services the procedure and returns data (i.e., a specified report) to the viewing application. The viewing application and stored procedures database 57 may allow users to submit report queries and other messages to the connectivity manager 26 over the Internet, a LAN, or other network connection. As described for the report browser interface 60, a user may also be able to modify a report that the viewing application displays. In some embodiments, the viewing application may also generate a PDF document of a returned report to display to a user.

It should be understood that the connectivity manager 26 may contain additional components and may contain multiple components as described above. For example, the connectivity manager 26 may include multiple report storing interface components. Each report storing interface component may provide different output formatting for different destinations. In some embodiments, the connectivity manager 26 is configured to output received data to multiple output devices and may use a separate report storing interface component for each destination. The connectivity manager 26 may also chain report storing interface components to provide an adapter between different messaging or communication protocols. For example, the connectivity manager 26 may include one report storing interface configured to accept AVP messages and generate corresponding SOAP messages and another report storing interface configured to accept SOAP messages and generate corresponding SQL scripts, procedures, or commands. The functionality that the components of the connectivity manager 26 provide, as described above, can also be combined in a variety of ways and configurations.

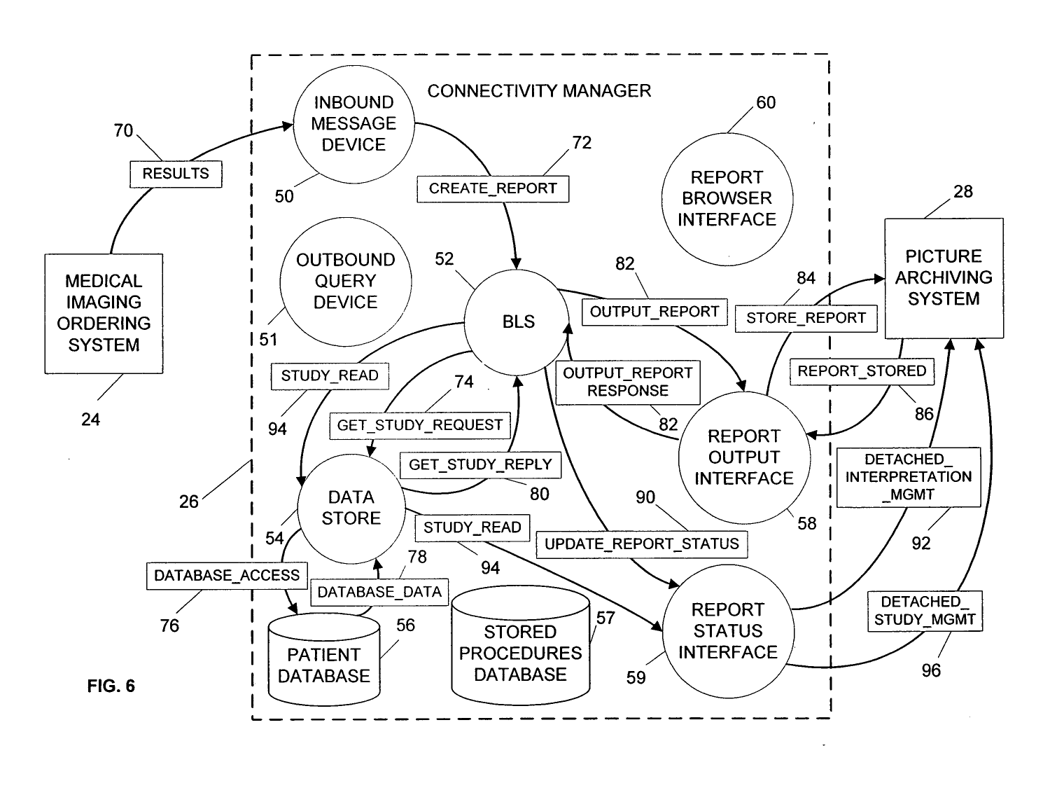

FIGS. 6-13 illustrate exemplary interactions and data flows between components of a medical information system, like those illustrated in FIGS. 1-5. FIG. 6 illustrates the process of storing a report including procedure results and/or procedure studies transmitted from the MIOS 24 or another reporting system to the PAS 28. In some embodiments, the first step of the process includes the MIOS 24 generating a procedure RESULTS message 70 containing the results of a completed procedure. The RESULTS message 70 may be an HL7-formatted message, an HTTP-formatted message, or the like. In some embodiments, the MIOS 24 transmits the procedure results to the connectivity manager 26 in a HL7 order unsolicited (“ORU”) message.

In some embodiments, the inbound message device 50 of the connectivity manager 26 receives the RESULTS message 70 transmitted from the MIOS 24. As previously described, the inbound message device 30 may be configured to format the data received in the RESULTS message 70 to data the BLS 52 understands. In some embodiments, the inbound message device 50 formats the message received from the MIOS 24 into a message following an attribute/value pairs protocol with sequenced items, such as the MCF protocol. In the next step of the process, the inbound message device 50 creates a CREATE_REPORT message 72 with all or some of the contents of the RESULTS message 70 and transmits the CREATE_REPORT message 72 to the BLS 52. The CREATE_REPORT message 72 may also contain processing instructions for the BLS 52.

Upon receiving the CREATE_REPORT message 72 the BLS 52 determines if the input device (i.e., the MIOS 24) that transmitted the RESULTS message 70 is a queriable device. As described above, the FIS 22 and/or the MIOS 24 may be queriable devices and may be able to receive and service queries or messages. The BLS 52 may use the queriable configuration of an input device to decide whether or not to store a report to the PAS 28. If a queriable input device transmits a message with procedure results, the results may be stored internally in the queriable input device and therefore may be retrieved as needed from the input device. If the input device is not queriable, however, the procedure results may be unretrievable from the input device. Therefore, results may be saved to the PAS 28 to allow the data to be retrieved later as needed.

If the input device is not queriable, the BLS 52 may obtain additional data for a report from the DS 54. The BLS 52 may generate a GET_STUDY_REQUEST message 74 and forward the message 74 to the DS 54. The GET_STUDY_REQUEST message 74 may be a MCF protocol formatted message or other formatted message acceptable to the DS 54. The GET_STUDY REQUEST message 74 may specify patient demographic information and/or procedure study information corresponding to the received procedure results to be obtained from the patient database 56. As previously described, the DS 54 may act as an access layer and may use the data in the GET_STUDY_REQUEST message 74 to query the patient database 56. The DS 54 generates a DATABASE_ACCESS message 76 following a standard database access language the patient database 56 understands, such as open database connectivity (“ODBC”). In some embodiments, the patient database 56 transmits the retrieved data to the DS 54 in a DATABASE_DATA message 78. The DS 54 may format the returned data and forward the data to the BLS 52 in a GET_STUDY_REPLY message 80.

The BLS 52 receives the GET_STUDY_REPLY message 80 from the DS 54 and creates a report using the data returned from the DS 54 and the data received in the CREATE_REPORT message 72. As previously described, the report may be generated in a markup language such as hypertext markup language (“HTML”) or extensible markup language (“XML”). After the report is generated, the BLS 52 sends an OUTPUT_REPORT message 82, which contains the generated report, to the report storing interface 58. In some embodiments, the OUTPUT_REPORT message 82 may be an AVP formatted message.

The report storing interface 58 receives the OUTPUT_REPORT message 82 containing the report and forwards the report to the PAS 28 in a STORE_REPORT message 84. In some embodiments, the STORE_REPORT message 84 is a SQL script or procedure, and causes the report and any related metadata to be stored in an SQL report table contained within the PAS 28. As previously described, the report storing interface 58 could also generate an intermediary message in a protocol such as a SOAP formatted message and forward the intermediary message to another report storing interface.

After the report storing interface 58 sends the STORE_REPORT message 84 to the PAS 28, the PAS 28 generates a return a REPORT_STORED message 86 to the report storing interface 58. The REPORT_STORED message 86 indicates whether the report was successfully stored. The report storing interface 58 forwards the storage status to the BLS 52 in an OUTPUT_REPORT_RESPONSE message 88. Upon receiving the OUTPUT_REPORT_RESPONSE message 88, the BLS 52 may check the message to determine if the report was successfully stored. If the message indicates a failure and/or indicates that an error occurred during the saving process, the BLS 52 retransmits the report and awaits another OUTPUT_REPORT_RESPONSE message 88. The BLS 52 may continue this process indefinitely until a successful save is performed or may attempt to store the report a predetermined number of times. The BLS 52 may also generate and log an error warning and save the report to an internal storage location or may abandon the report if it cannot be successfully stored. The BLS 52 may also attempt to recreate a report and/or re-query the patient database and attempt to save the new report.

If the OUTPUT_REPORT_RESPONSE message 88 indicates success, the BLS 52 sends an UPDATE_REPORT_STATUS message 90 to the report status interface 59. The UPDATE_REPORT_STATUS message 90 may include a report status and an accession number, a procedure study identification number, or the like, used to identity the report. The report status may be set to “READ” or “PRELIMINARY” and may be used to determine operations that can be performed on the report and/or to ensure that the most recent report is displayed, modified, and/or processed. The report status interface 59 generates a DETACHED_INTERPRETATION_MANAGEMENT (“MGMT”) message 92 and transmits the message 92 to the PAS 28. The DETACHED_INTERPRETATION_MGMT message 92 may be a DICOM formatted message and may include the data provided in the UPDATE_REPORT_STATUS message 90. In some embodiments, the report status interface may store report status data to a separate storage device in place of or in addition to the PAS 28.

If the OUTPUT_REPORT_RESPONSE message 88 transmitted to the BLS 52 from the report storing interface 58 indicates successful storage, the BLS 52 may also generate a STUDY_READ message 94. The STUDY_READ message 94 may include report status data and may also include report identification data such as a procedure study identification number, patient identifier, or the like. In some embodiments, the BLS 52 sends the STUDY_READ message 94 to the DS 54. The DS 54 receives the message and updates the patient database 54 with the data regarding report status sent from the BLS 52. The DS 54 may also be configured to forward the STUDY_READ message 94 to other components of the connectivity manager 26 configured to accept the STUDY_READ message 94, such as the report status interface 59. The report status interface 59 may receive the STUDY_READ message 94 from the DS 54 and may send a DETACHED_STUDY_MGMT message 96 to the PAS 28. The PAS 28 may use the data contained within the DETACHED_STUDY_MGMT message 96 to update and/or verify report status data contained in the PAS 28.

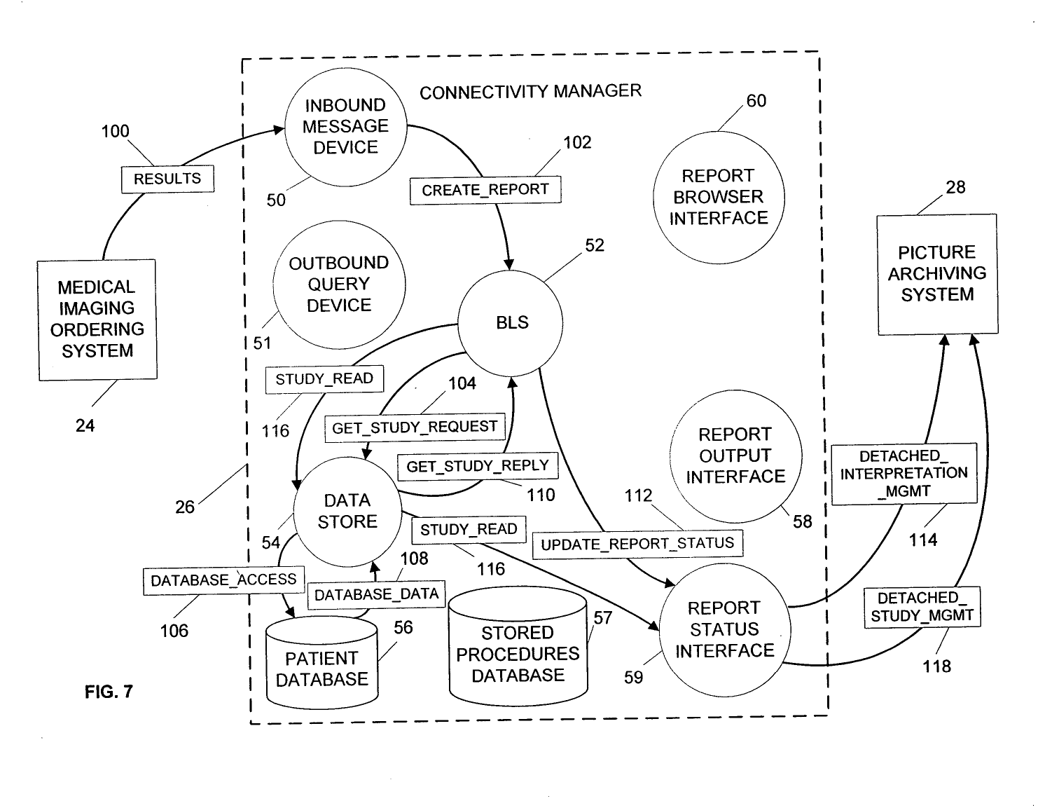

FIG. 7 illustrates another process of storing a report transmitted from the MIOS 24 to the PAS 28. In particular, FIG. 7 illustrates a process of storing a report when the MIOS 24 is a queriable device. As previously described, if the MIOS 24 is a queriable device, the connectivity manager 26 may not store procedure results or studies in a report to the PAS 28 since the connectivity manager 26 can query the MIOS 24 for procedure results and studies as needed. The preliminary steps of the process when the MIOS 24 is queriable are similar to when the MIOS 24 is not queriable. The first steps include the MIOS 24 generating a procedure RESULTS message 100 containing the results of a procedure, the inbound message device receiving the RESULTS message 100, and transmitting a CREATE_REPORT message 102 to the BLS 52.

As previously described, upon receiving the CREATE_REPORT message 102 the BLS 52 determines whether the input device (the MIOS 24) that transmitted the RESULTS message 100 is a queriable device. When the input device is queriable, the BLS 52 may ignore the CREATE_REPORT message 102 and may not forward the report to the PAS 28. The BLS 52 may, however, track the status of the procedure results received from the MIOS 24. In some embodiments, the BLS 52 tracks the status of the report or procedure data to ensure that the most recent data is displayed and/or processed. To track report status, the BLS 52 may obtain data from the DS 54 to identify the report. In some embodiments, the BLS 52 generates a GET_STUDY_REQUEST message 104 and forwards the message 104 to the DS 54 to obtain patient demographic data and/or procedure study data corresponding to the received procedure results. The DS 54 may generate a DATABASE_ACCESS message 106 to query the patient database 56 for the required data. In some embodiments, the patient database 56 transmits the retrieved data to the DS 54 in a DATABASE_RESPONSE message 108. The DS 54 may format the returned data and forward the data to the BLS 52 in a GET_STUDY_REPLY message 110.

The BLS 52 receives the GET_STUDY_REPLY message 110 from the DS 54 and creates an UPDATE_STATUS message 112 to the report status interface 59. The UPDATE_STATUS message 112 may include a report status and an accession number, a procedure study identification number, or the like, used to identity the procedure results received in the CREATE_REPORT message 104. The report status interface 59 may generate and transmit a DETACHED_INTERPRETATION_MGMT message 114 to the PAS 28 where the PAS 28 updates and/or verifies data it contains according to the data contained in the DETACHED_INTERPRETATION_MGMT message 114.

Upon receiving the GET_STUDY_RESPONSE message 110 from the DS 54, the BLS 52 may also generate a STUDY_READ message 116. In some embodiments, the BLS 52 sends the STUDY_READ message 116 to the DS 54. The DS 54 receives the message and updates the patient database 54 as directed. The DS 54 may also be configured to forward the STUDY_READ message 116 to other components requiring report or report status data, such as the report status interface 59. The report status interface 59 may receive the STUDY_READ message 116 from the DS 54 and may send a DETACHED_STUDY_MGMT message 118 to the PAS 28. The PAS 28 may use the data contained within the DETACHED_STUDY_MGMT message 118 to create, update, and/or verify report status data contained in the PAS 28.

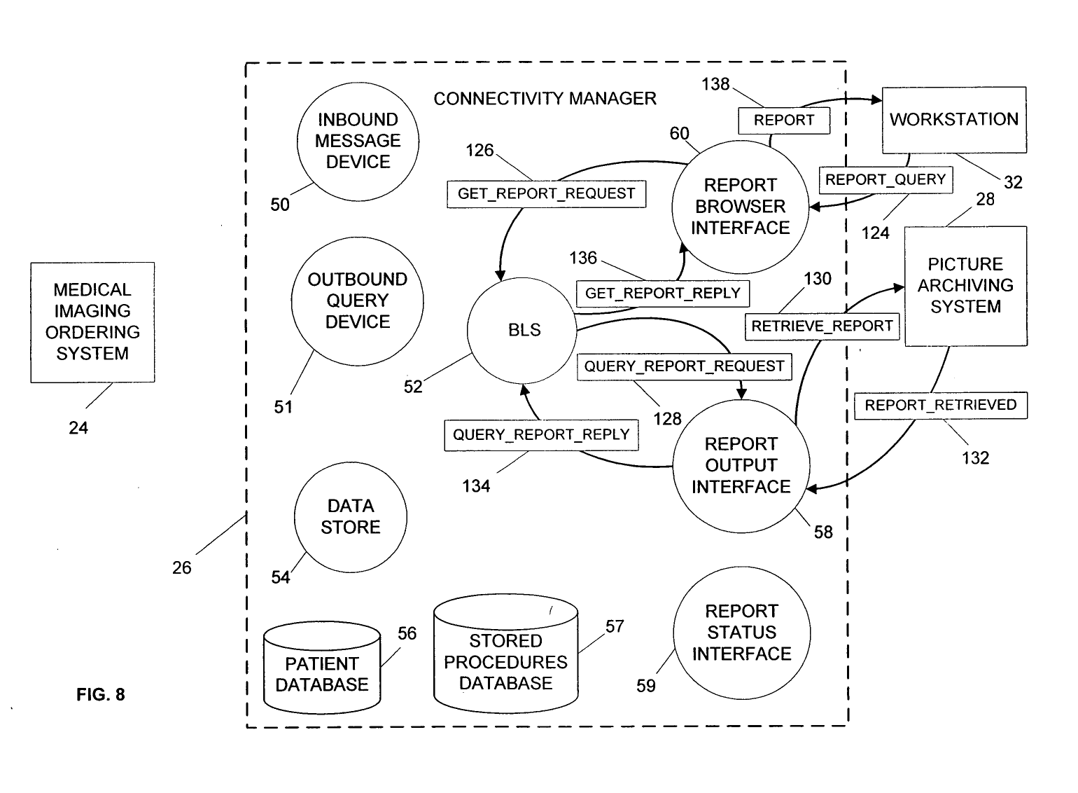

FIG. 8 illustrates a process of retrieving a report from an external device, such as the workstation 32. In a first step of the process, a REPORT_QUERY message 124 is generated at the workstation 32. The REPORT_QUERY message 124 may be an HTTP message that contains accession number, patient number, and/or other identifying data for a report. In some embodiments, the workstation 32 accesses the connectivity manager 26 via a universal resource locator (“URL”) over the Internet, a LAN, or another network connection.

The REPORT_QUERY message 124 may be transmitted to the report browser interface 60 of the connectivity manager 26. In some embodiments, the report browser interface 60 includes a web server executing a Java server page (“JSP”). The web server may execute the report browser interface 60 JSP and may generate and transmit a GET_REPORT_REQUEST message 126 with the data contained in the REPORT_QUERY message 124 to the BLS 52. In some embodiments, the GET_REPORT_REQUEST message 126 is an AVP formatted message acceptable to the BLS 52.

Upon receiving the GET_REPORT_REQUEST message 126, the BLS 52 may first determine whether the MIOS 24 or other input device is a queriable device. As previously described, if the MIOS 24 or other input device is a queriable device, the procedure results and/or studies may not be stored in the PAS 28 in a report and may be internally stored in the queriable input device. If the MIOS 24 is not queriable, the BLS 52 may generate a QUERY_REPORT_REQUEST message 128. The BLS 52 may forward the QUERY_REPORT_REQUEST message 128 to the report storing interface 59. In response, the report storing interface 59 may generate and transmit a RETRIEVE_REPORT message 130 to the PAS 28. When the PAS 28 receives the RETRIEVE_REPORT message 130 from the report storing interface 59, the PAS 28 retrieves the report specified in the RETRIEVE_REPORT message 130. The PAS 28 may return the retrieved report in a REPORT_RETRIEVED message 132 to the report storing interface 59. If the PAS 28 cannot retrieve the report specified in the RETRIEVE_REPORT message 130, the PAS 28 may send an empty report and/or may send an error condition, warning, or indication in the REPORT_RETRIEVED message 132. As previously described, the returned report may be an XML report or other markup language report.

In some embodiments, the report storing interface 59 forwards the returned report in a QUERY_REPORT_REPLY message 134 to the BLS 52. The BLS 52 receives the QUERY_REPORT_REPLY message 134 and forwards the report in a GET_REPORT_REPLY message 136 to the report browser interface 60. The report browser interface 60 may receive the GET_REPORT_REPLY message 136, which contains the report, and may process and/or format the report such that the workstation 32 can accept and display the report. In some embodiments, the report browser interface 60 converts the report into a hypertext markup language (“HTML”) page. The formatted report is sent to the workstation 32 in a REPORT message 138 and the workstation 32 displays the report to a user.

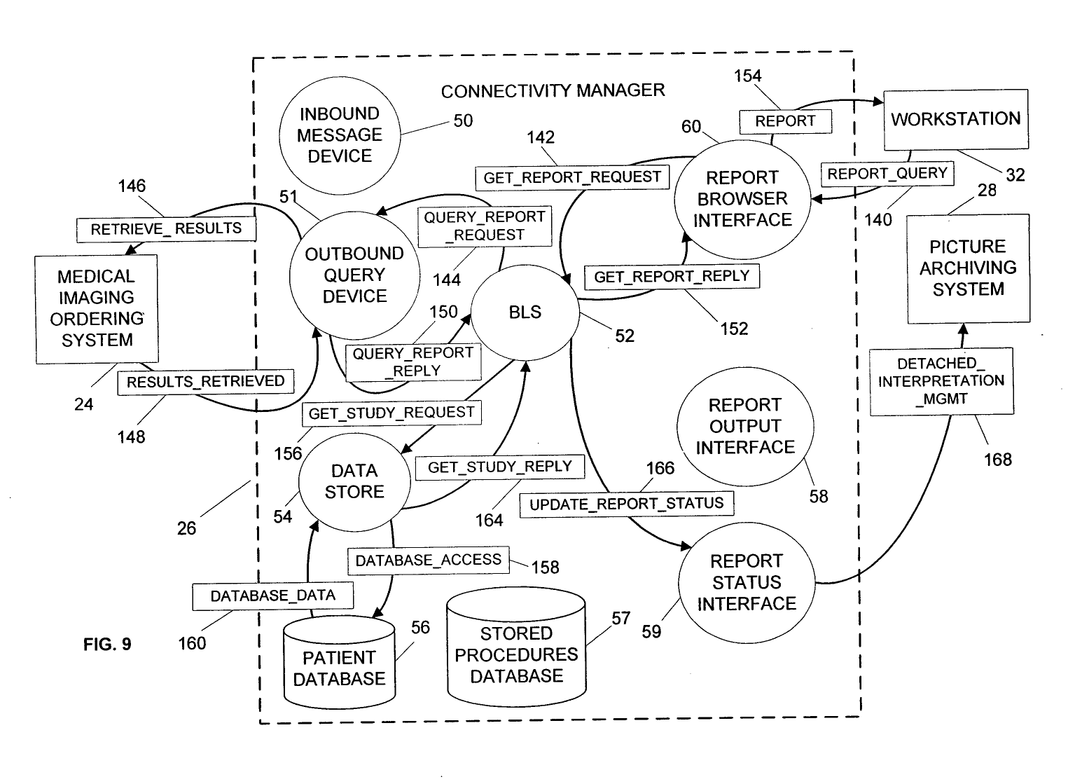

FIG. 9 illustrates another process of retrieving a report from an external device when the medical imaging system 24 is queriable. The first steps of the process are similar to those described for FIG. 8. A REPORT_QUERY message 140 is generated at the workstation 32 and transmitted to the report browser interface 60. The report browser interface 60 generates and transmits a GET_REPORT_REQUEST message 142 with the data contained in the REPORT_QUERY message 140 to the BLS 52. Upon receiving the GET_REPORT_REQUEST message 142, the BLS 52 determines whether the MIOS 24 or other input device is a queriable device. When the MIOS 24 is queriable, the BLS 52 may generate and transmit QUERY_RESULTS_REQUEST message 144 to the outbound query device 51. The outbound query device 51, in response, may generate and transmit a RESULTS_RETRIEVE message 146 to the MIOS 24. As previously described, the outbound query device 51 may convert internal queries or messages of the connectivity manager 26 into queries or messages that can be transmitted to the MIOS 24. In some embodiments, the outbound query device 51 converts MCF formatted messages transmitted from the BLS 52 into HL7 formatted messages acceptable to the MIOS 24.

When the MIOS 24 receives the REPORT_RETRIEVE message 146 from the outbound query device 51, the MIOS 24 finds and returns the data specified in the RETRIEVE_REPORT message 146. The medical imaging ordering system may return the retrieved data in a RESULTS_RETRIEVED message 148 to the outbound query device 51. If the MIOS 24 cannot retrieve the data specified in the RETRIEVE_REPORT message 146, the system 24 may send an empty message and/or may send an error condition, warning, or indication in the RESULTS_RETRIEVED message 148.

In some embodiments, the outbound query device 51 forwards the returned data in a QUERY_RESULTS_REPLY message 150 to the BLS 52. In some embodiments, the BLS 52 receives the QUERY_RESULTS_REPLY message 150 and determines whether the data specified in the QUERY_RESULTS_REQUEST message 144 was successfully retrieved. If the QUERY_RESULTS_REPLY message 150 sent from the outbound query device 51 indicates that the data was not retrieved and therefore was not returned, the BLS 52 may forward the empty message and/or error condition specified in the QUERY_RESULTS_REPLY message 150 to the report browser interface 60 in a GET_REPORT_REPLY message 152. The BLS 52 may also generate an empty or error report and forward the report to the report browser interface 60. The report browser interface 60 may receive the GET_REPORT_REPLY message 152, which contains an empty message or report and/or an error condition or report, and may generate an HTML indicating a non-existing report error. The report error is sent to the workstation 32 in a REPORT message 154, and the workstation can display the message to a user.

If, however, the report was successfully found and transmitted from the MIOS 24, the BLS 54 may generate a GET_STUDY_REQUEST message 154 and forward the message 156 to the DS 54. The GET_STUDY_REQUEST message 156 may specify patient demographic data and/or procedure study data for the patient and/or procedure corresponding to the received procedure results from the MIOS 24. In some embodiments, since the MIOS 24 is queriable, a report containing both procedure data transmitted from the MIOS 24 and patient and procedure data stored in the patient database 56 is not generated and saved. Therefore, the BLS 54 obtains additional data from the DS 54 to add to the results received from the queriable MIOS 24.

To obtain additional data from the patient database 56, the DS 54 generates a DATABASE_ACCESS message 158, and the patient database 56 transmits the retrieved data to the DS 54 in a DATABASE_DATA message 160. The DS 54 forwards the data to the BLS 52 in a GET_STUDY_REPLY message 162.

The BLS 52 receives the GET_STUDY_REPLY message 162 from the DS 54 and creates a report using the data returned from the DS 54 and the data received from the queriable MIOS 24. As previously described, the report may be generated in a markup language such as hypertext markup language (“HTML”) or extensible markup language (“XML”). The BLS 52 sends the report to the report browser interface 60 in the GET_REPORT_REPLY message 152, and the report browser interface 60 forwards the report to the workstation 32 in the REPORT message 164. The workstation 32 may then display the retrieved report to a user.

The BLS 52 may also send an UPDATE_REPORT_STATUS message 166 to the report status interface 59. The status of the report may have changed internally on the queriable medical imaging ordering system 26 and the status change may be documented on the PAS 28. The report status interface 59 may receive the UPDATE_REPORT_STATUS message 166 from the BLS 52 and may send a DETACHED_INTERPRETATION_MGMT message 168 to the PAS 28 with the status of the report and other report identifying data. The PAS 28 receives the message 168 and updates the data in the PAS 28 accordingly.

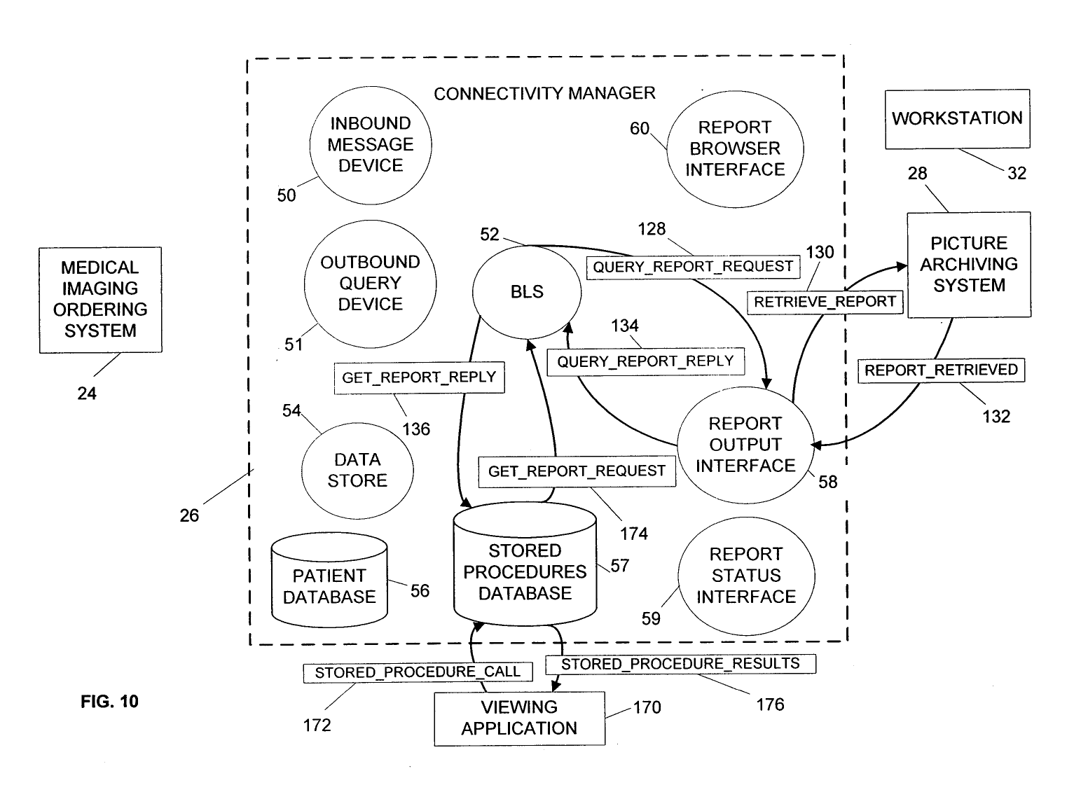

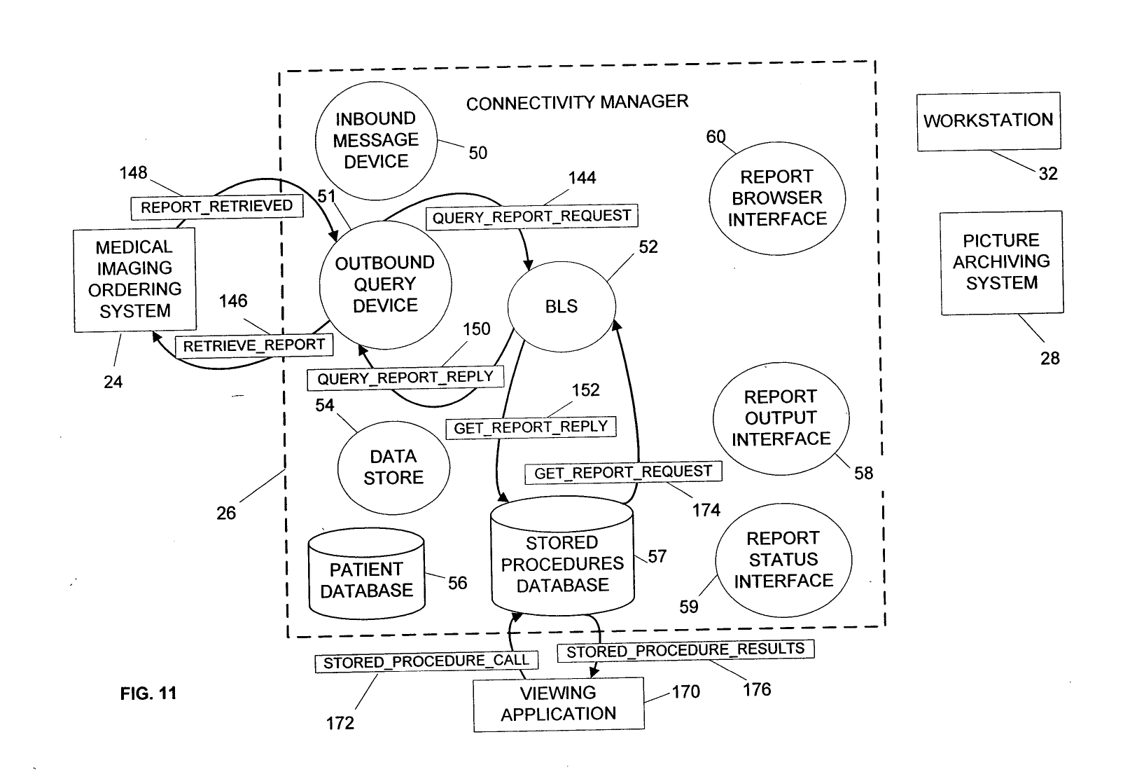

FIGS. 10 and 11 illustrate additional exemplary processes for retrieving a report. As previously described, a viewing application 170 running on a web/application server may interact with the stored procedures database 57 to query the connectivity manager 26 for reports for viewing and/or modifying. FIG. 10 illustrates the data flow performed when the MIOS 24 is not queriable and FIG. 11 illustrates the data flow performed when the MIOS 24 is queriable. As seen in both FIG. 10 and FIG. 11, the viewing application 170 generates a STORED_PROCEDURE_CALL message 172 and forwards the message 172 to the stored procedures database 57. The stored procedure database 57 retrieves a procedure, formats the procedure as needed, and transmits a GET_REPORT_REQUEST 174 to the BLS 52. The GET_REPORT_REQUEST message 174 transmitted from the stored procedures database 57 may be similar to the GET_REPORT_REQUEST messages transmitted from the report browser interface 60 with respect to FIGS. 8 and 9.

When the MIOS 24 is queriable (see FIG. 10), upon receiving the GET_REPORT_REQUEST message 174 from the stored procedures database 57, the BLS 52 operates as described for FIG. 8 and transmits a QUERY_REPORT_REQUEST 128 to the report output interface 58. The report output interface 58 receives the message 128 and sends a RETRIEVE_REPORT message 130 to the PAS 28. The PAS 28 retrieves the report specified in the RETRIEVE_REPORT message 130 and sends the report to the report output interface 58 in a REPORT_RETRIEVED message 132. The report output interface 58 forwards the retrieved report to the BLS 52 in a QUERY_REPORT_REPLY message 134.

When the MIOS 24 is not queriable (see FIG. 10), upon receiving the GET_REPORT_REQUEST message 174 from the stored procedures database 57, the BLS 52 operates as described for FIG. 9 and transmits a QUERY_REPORT_REQUEST 144 to the outbound query device 51. The outbound query device 51 receives the message 144 and sends a RETRIEVE_REPORT message 148 to the queriable MIOS 24. The MIOS 24 retrieves the report specified in the RETRIEVE_REPORT message 148 and sends the report to the outbound query device 51 in a REPORT_RETRIEVED message 148. The outbound query device 51 forwards the retrieved report to the BLS 52 in a QUERY_REPORT_REPLY message 150

In both system configurations (i.e., queriable and non-queriable MIOS), the retrieved report is returned to the BLS 52 and is returned to the viewing application 170 in a STORED_PROCEDURE_RESULTS message 176.

It should be understood that the retrieval processes illustrated and described in FIGS. 8-11 may be used to retrieve a single report, one or more reports for a particular patient, one or more reports for a particular procedure, one or more reports for a particular time period, and any combination thereof.

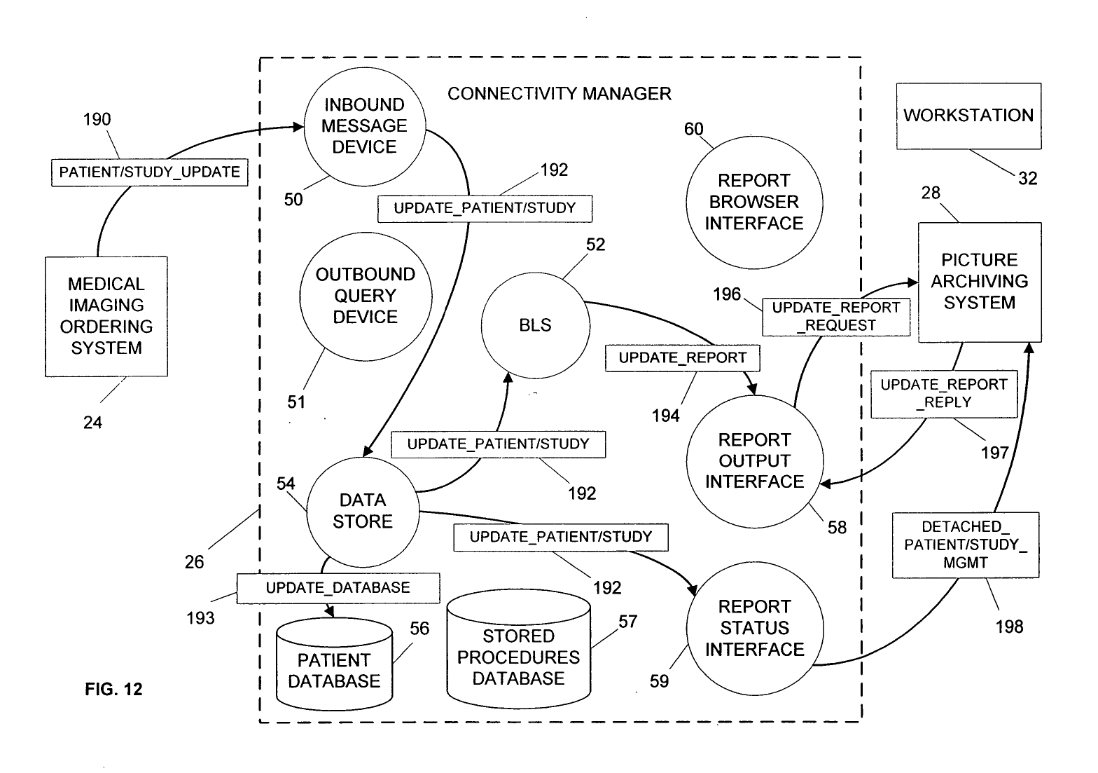

FIG. 12 illustrates exemplary data flow for updating data in a medical information system. In some embodiments, an update includes a patient update, a procedure or procedure update, a patient merge, or any combination thereof. An update may originate from the FIS 22, the MIOS 24, or another information system. As seen in FIG. 12, the MIOS 24 sends the inbound message device 50 a PATIENT/STUDY_UPDATE message 190. In some embodiments, the PATIENT/STUDY_UPDATE message 190 includes an HL7 ADT patient update message or an HL7 ORU order update message. The inbound message device 50 receives and parses the message 190 and sends an UPDATE_PATIENT/STUDY message 192 to the DS 54.

The DS 54 receives the UPDATE_PATIENT/STUDY message 192 and updates the appropriate data in the patient database 56 with an UPDATE_DATABASE message 193. In some embodiments, the DS 54 updates the patient database 56 using an ODBC update message.

The DS 54 may also forward the UPDATE_PATIENT/STUDY message 192 to other components of the connectivity manager 26. The BLS 52 may receive the UPDATE_PATIENT/STUDY message 192 and may generate an UPDATE_REPORT message 194 for the report storing interface 58. The report storing interface 58 receives the UPDATE_REPORT message 194 and generates an UPDATE_REPORT_REQUEST message 196. The report storing interface 58 forwards the UPDATE_REPORT_REQUEST message 196 to the PAS 28, where the PAS 28 updates the designated data and returns an UPDATE_REPORT_REPLY message 197 to the report storing interface 58.

The report status interface 59 may also receive the UPDATE_PATIENT/STUDY message 192 transmitted from the DS 54. In some embodiments, the report status interface 59 receives the UPDATE_PATIENT/STUDY message 192 and transmits a DETACHED_PATIENT/STUDY_MGMT message 198 to the PAS 28. Upon receiving the DETACHED_PATIENT/STUDY_MGMT message 198 the PAS 28 updates and/or verifies the data specified in the message 198.

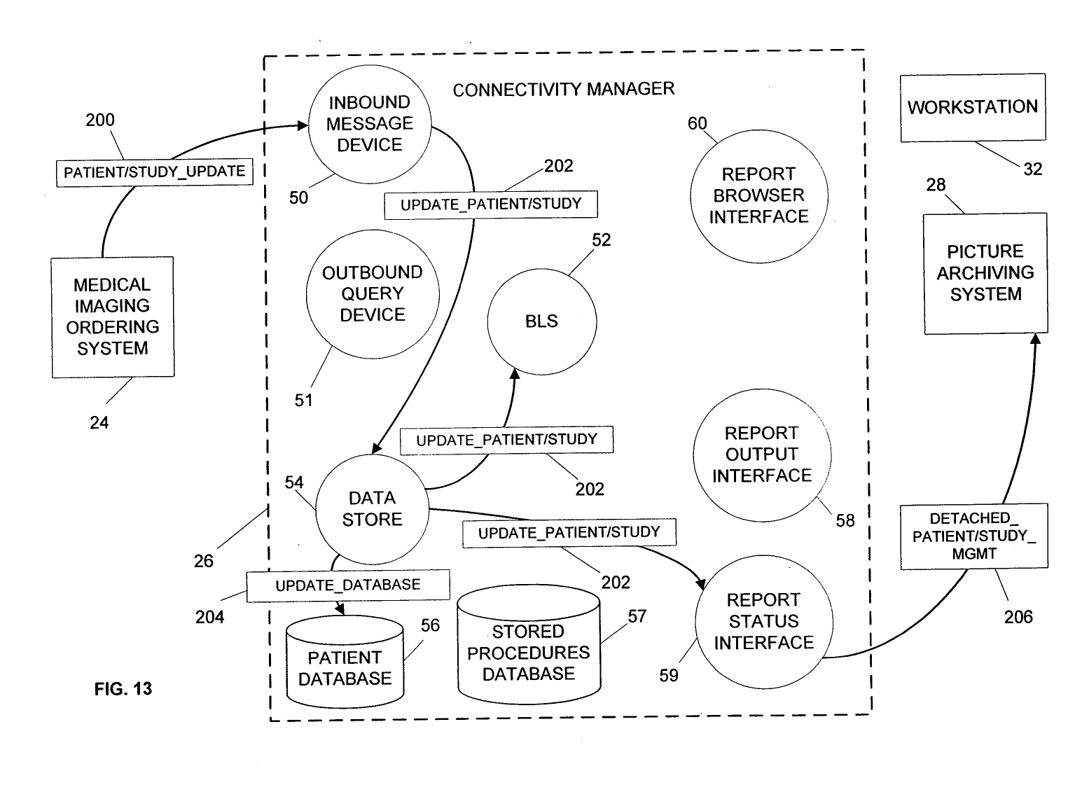

FIG. 13 illustrates a similar process of updating data in a medical information system when the MIOS 24 is queriable. As seen in FIG. 13, the preliminary steps of the process are similar. The MIOS 24 transmits a PATIENT/STUDY_UPDATE message 200 that contains the updated data to the inbound message device 50. The inbound message device 50 generates and transmits an UPDATE_PATIENT/STUDY message 202 to the DS 54. The DS 54 updates the patient database 56 using an UPDATE_DATABASE message 204 as designated in the UPDATE_PATIENT/STUDY message 202 and forwards the UPDATE_PATIENT/STUDY message 202 to the BLS 52 and the report status interface 59.

The BLS 52 may receive the UPDATE_PATIENT/STUDY message 202 from the DS 54. However, the subsequent report updating actions are optional. The MIOS 24 may be queriable and, therefore, a report may not have been saved to the PAS 28 that would require an update.

The report status interface 59 does, however, generate a DETACHED_PATIENT/STUDY_MGMT message 206 upon receiving the UPDATE_PATIENT/STUDY message 202 from the DS 54. The report status interface 59 sends the DETACHED_PATIENT/STUDY_MGMT message 206 to the PAS 28 where the appropriate data is updated.

It should be understood that the components shown in FIGS. 1-13 represent exemplary configurations. Additional components or multiple components of those shown may be added. Components may also be combined or broken down into separate components. For example, the functionality of the inbound message device 50 may be included in the BLS 52. The inbound message device 50 may also be broken down into multiple components including a message buffer, a parser, a mapping device, or the like. Components such as the data store 54, patient database 56, stored procedures database 57, report browser interface 60, and report status interface 59 may also be removed from the connectivity manager 26 and added to other components of the medical information system or configured as stand-alone external devices. For example, the data contained in the patient database may be stored on and retrieved from the MIOS 24.

The process steps illustrated in FIGS. 6-13 are exemplary in order and content, and the processes can be accomplished with a subset of the depicted steps or additional and alternative steps. It should also be understood that the above exemplary processes or data flows may be combined and arranged in various configurations, and the order of the individual steps of the exemplary process is for illustrative purposes only and may be executed in other sequences. For example, the connectivity manager 26 may communicate with queriable input devices and non-queriable input devices and, therefore, may perform both the exemplary processes specified for queriable input devices and the processes specified for non-queriable input devices. In some embodiments, even when an input device such as the MIOS 24 is queriable, the connectivity manager 26 may be configured to store results received from the queriable input device to the PAS 28. For example, the connectivity manager 26 may be configured to determine whether or not to save results received from a queriable input device to the PAS 28 in a report based on the status of the results. The connectivity manager 26 may be configured to store all results received from a queriable input device to the PAS 28 that do not have a predetermined status, such as “final.” The connectivity manager 26 may store all “non-final” results in a report to the PAS 28 such that the results can be easily retrieved from the PAS 28 as they are updated and/or modified as their status changes (i.e., “preliminary” to “final”). The connectivity manager 26 may similarly use the status of a report to determine where to retrieve a report. Reports with a status of “final” may be retrieved from a queriable input device and reports with a status other than “final” may be retrieved from the PAS 28.

As should also be apparent to one of ordinary skill in the art, the systems shown in the figures are models of what actual systems might be like. As noted, many of the modules and logical structures described are capable of being implemented in software executed by a microprocessor or a similar device or of being implemented in hardware using a variety of components including, for example, application specific integrated circuits (“ASICs”). In addition, terms like “processor” may include or refer to both hardware and/or software. Further still, throughout the specification capitalized terms are used. Such terms are used to conform to common practices and to help correlate the description with the coding examples and drawings. However, no specific meaning is implied or should be inferred simply due to the use of capitalization. Thus, the claims should not be limited to the specific examples or terminology or to any specific hardware or software implementation or combination of software or hardware.

Various features and advantages of the invention are set forth in the following claims.

1. A connectivity manager for use in a medical information system, the medical information system including a facility information system, a medical imaging ordering system, and a picture archiving system, the connectivity manager configured to use message-based communications to receive messages from the medical imaging ordering system, store reports in the picture archiving system, and retrieve reports from the picture archiving system.

2. A connectivity manager as claimed in claim 1, wherein the connectivity manager is configured to receive messages from the medical imaging ordering system that include procedure results.

3. A connectivity manager as claimed in claim 2, further configured to generate a report based on the procedure results.

4. A connectivity manager as claimed in claim 3, further configured to receive additional data from a data store.

5. A connectivity manager as claimed in claim 4, wherein the connectivity manager is configured to generate a report based on the procedure results and the additional data.

6. A connectivity manager as claimed in claim 1, further configured to retrieve reports from the medical imaging ordering system.

7. A connectivity manager as claimed in claim 6, wherein the connectivity manager is configured to retrieve reports from the medical imaging ordering system when the medical imaging ordering system is a queriable device.

8. A connectivity manager as claimed in claim 1, wherein the connectivity manager is configured to receive messages from the medical imaging ordering system that include updated data.

9. A connectivity manager as claimed in claim 8, further configured to update reports stored in the picture archiving system using message-based communications based on the updated data.

10. A connectivity manager as claimed in claim 1, further configured to receive messages from a workstation.

11. A connectivity manager as claimed in claim 1, wherein the connectivity manager is configured to receive messages from a workstation that include report queries.

12. A connectivity manager as claimed in claim 11, further configured to forward retrieved reports to the workstation.

13. A connectivity manager as claimed in claim 1, further configured to receive messages from the facility information system using message-based communications.

14. A connectivity manager as claimed in claim 13, wherein the connectivity manager is configured to receive messages from the facility information system that include updated data.

15. A connectivity manager as claimed in claim 14, further configured to update reports stored in the picture archiving system using message-based communications based on the updated data.

16. A connectivity manager as claimed in claim 1, further configured to receive messages from a gateway.

17. A connectivity manager as claimed in claim 16, wherein the connectivity manager is configured to receive messages from that gateway that include messages transmitted from a medical imaging ordering system.

18. A connectivity manager as claimed in claim 1, further configured to receive messages from a viewing application interacting with a stored procedures database.

19. A connectivity manager as claimed in claim 18, wherein the connectivity manager is configured to receive message from the viewing application that includes report queries.

20. A connectivity manager as claimed in claim 19, further configured to forward retrieved reports to the viewing application.

21. A connectivity manager as claimed in claim 1, further configured to transmit worklists to one or more imaging modalities.

22. A connectivity manager as claimed in claim 21, wherein the one or more imaging modalities includes at least one of a computer-aided tomography modality, an ultrasound modality, a magnetic resonance imaging modality, and an X-ray modality.

23. A connectivity manager as claimed in claim 21, further configured to receive status messages from the one or more imaging modalities.

24. A connectivity manager as claimed in claim 23, further configured to forward status messages received from the one or more imaging modalities to at least one of the medical information system and the facility information system.

25. A method of storing a first medical report in a medical information system, the medical information system including a medical imaging ordering system, a connectivity manager, and a picture archiving system, the method comprising:
transmitting the first medical report in a first message from the medical imaging ordering system to the connectivity manager;
generating a second message with a second medical report based on the first medical report, transmitting the second message to the picture archiving system from the connectivity manager without internally storing the first report or the second report, and storing the second medical report in the picture archiving system when the medical imaging ordering system is not a queriable device; and
ignoring the first message without internally storing the first report when the medical imaging ordering system is a queriable device.

26. A method as claimed in claim 25, further comprising receiving additional data from a data store when the medical imaging ordering system is not a queriable device.

27. A method as claimed in claim 26, wherein the second medical report is also based on the additional data received from the data store.

28. A method as claimed in claim 25, wherein the first message includes a health level 7 formatted message.

29. A method as claimed in claim 25, wherein the second report includes an extensible markup language formatted report.

30. A method as claimed in claim 25, wherein the second message includes a digital imaging and communications in medicine formatted message.

31. A method as claimed in claim 25, wherein storing the second medical report in the picture archiving system includes storing the second medical report in a structured query language table.

32. A method of retrieving a medical report in a medical information system, the medical information system including a medical imaging ordering system, a connectivity manager, and a picture archiving system, the method comprising:
transmitting a report query for a report to the connectivity manager;
generating a first query, transmitting the first query from the connectivity manager to the medical imaging ordering system, and retrieving the report from the medical imaging ordering system when the medical imaging ordering system is a queriable device; and
generating a second query, transmitting the second query from the connectivity manager to the picture archiving system, and retrieving the report from the picture archiving system when the medical imaging ordering system is not a queriable device.

33. A method as claimed in claim 32, wherein receiving a report query for a report includes receiving a report query from a workstation.

34. A method as claimed in claim 32, further comprising generating a displayable report from the report.

35. A method as claimed in claim 34, wherein the displayable report includes a hypertext markup language formatted report.

36. A method as claimed in claim 34, wherein the displayable report includes an extensible markup language formatted report.

37. A method as claimed in claim 32, further comprising the connectivity manager generating a query interface on a workstation.

38. A method as claimed in claim 37, wherein the query interface includes an active server page interface.

39. A method as claimed in claim 37, wherein receiving the report query for a report includes receiving the report query from a view application interacting with a stored procedures database.

40. A connectivity manager for use in a medical information system, the medical information system including a medical imaging ordering system and a picture archiving system, the connectivity manager comprising:
an input device configured to interact with the medical imaging ordering system and to convert a message from a first format to a second format;
a business logic server configured to interact with the input device and to generate a report;
a data store configured to interact with the business logic server;
a report storing interface configured to interact with the business logic server and the picture archiving system;
a report browser interface configured to interact with the business logic server; and
a report status interface configured to interact with the business logic server.

41. A connectivity manager as claimed in claim 40, wherein the input device is further configured to interact with the business logic server.

42. A connectivity manager as claimed in claim 41, wherein the input device is further configured to convert a health level 7 formatted message to an attribute/value pairs formatted message.

43. A connectivity manager as claimed in claim 42, wherein the input device is further configured to forward the attribute/value pairs formatted message to the business logic server.

44. A connectivity manager as claimed in claim 43, wherein the input device is further configured to convert an attribute/values pairs formatted message to a health level 7 formatted message.

45. A connectivity manager as claimed in claim 44, wherein the input device is further configured to forward the health level 7 formatted message to the medical imaging ordering system.

46. A connectivity manager as claimed in claim 40, wherein the business logic server is further configured to obtain additional data from the data store.

47. A connectivity manager as claimed in claim 46, wherein the business logic server is configured to generate a report based on one or more messages received from the input device and the additional data.

48. A connectivity manager as claimed in claim 40, wherein the business logic server is further configured to forward the report to the report storing interface.

49. A connectivity manager as claimed in claim 40, wherein the business logic server is further configured to generate a report query based on one or more messages received from the input device.

50. A connectivity manager as claimed in claim 49, wherein the business logic server is further configured to forward a report query to the report storing interface.

51. A connectivity manager as claimed in claim 40, wherein the business logic server is further configured to forward a report status of the report to the report status interface.

52. A connectivity manager as claimed in claim 40, wherein the data store is further configured to interact with a patient database.

53. A connectivity manager as claimed in claim 52, wherein the data store is configured to interact with the patient database using an open database connectivity access language.

54. A connectivity manager as claimed in claim 40, wherein the report storing interface is configured to store a report transmitted from the business logic server in the picture archiving system.

55. A connectivity manager as claimed in claim 40, wherein the report storing interface is configured to retrieve a report stored to the picture archiving system specified in a report query transmitted from the business logic server.

56. A connectivity manager as claimed in claim 40, wherein the report browser interface is further configured to interact with a workstation.

57. A connectivity manager as claimed in claim 56, wherein the report browser interface is further configured to receive a report query from the workstation.

58. A connectivity manager as claimed in claim 57, wherein the report browser interface is further configured to display a report on the workstation.

59. A connectivity manager as claimed in claim 58, wherein the report browser is configured to display a hypertext markup language formatted report.

60. A connectivity manager as claimed in claim 40, wherein the report status interface is further configured to store a report status to the picture archiving system.

61. A connectivity manager as claimed in claim 40, wherein the report status interface is further configured to interact with an adapter.

62. A connectivity manager for use in a medical information system, the medical information system including a queriable medical imaging ordering system and a picture archiving system, the connectivity manager configured to
receive a first message including a first report from the medical imaging ordering system, and, if the first report includes a first status not equal to a predetermined status, to generate a second report based on the first report and to transmit a second message including a second report to the picture archiving system.

63. A connectivity manager as claimed in claim 62, further configured to obtain additional data from a data store if the first status is not equal to the predetermined status.

64. A connectivity manager as claimed in claim 63, wherein the connectivity manager is configured to generate the second report based on the first report and the additional data if the first status is not equal to the predetermined status.

65. A connectivity manager as claimed in claim 62, wherein the first predetermined status includes a FINAL status.

66. A connectivity manager as claimed in claim 62, wherein the first message includes a health level 7 formatted message.

67. A connectivity manager as claimed in claim 62, wherein the second message includes a digital imaging and communications in medicine formatted message.

68. A connectivity manager as claimed in claim 62, wherein the second report includes an extensible markup language formatted report.

69. A connectivity manager as claimed in claim 62, further configured to receive a report query for a second report.

70. A connectivity manager as claimed in claim 69, wherein the second report includes a second status.

71. A connectivity manager as claimed in claim 70, further configured to retrieve the medical report from the queriable medical imaging ordering system when the second status is equal to the predetermined status.

72. A connectivity manager as claimed in claim 70, further configured to retrieve the medical report from the picture archiving system when the second status is not equal to the predetermined status.

73. A connectivity manager for use in a medical information system, the medical information system including a first medical imaging ordering system and a gateway, the gateway configured to communicate with the first medical imaging ordering system using a non-public communication protocol and to communicate with the connectivity manager using a public communication protocol; the connectivity manager configured to communicate with the gateway using a public communication protocol.

74. A connectivity manager as claimed in claim 73, wherein the connectivity manager is configured to communicate with the gateway using message-based communications.

75. A connectivity manager as claimed in claim 73, wherein the connectivity manager is configured to communicate with a second medical imaging ordering system.

76. A connectivity manager as claimed in claim 73, wherein the connectivity manager is configured to receive data from the first medical imaging ordering system through the gateway.

77. A connectivity manager as claimed in claim 76, wherein the connectivity manager is configured to generate reports based on the data.

78. A connectivity manager as claimed in claim 77, wherein the connectivity manager is configured to store the reports.

79. A connectivity manager as claimed in claim 73, wherein the connectivity manager is configured to query the first medical imaging ordering system through the gateway for data if the first imaging ordering system is a queriable device.
